(19) United States
(12) Patent Application Publication
(10) Pub. No.: US 2008/0022159 A1
(43) Pub. Date: Jan. 24, 2008

(54) METHOD FOR DETECTING ABNORMAL INFORMATION PROCESSING APPARATUS

(76) Inventors: Sei Kato, Kawasaki-shi (JP); Takahide Nogayama, Yamato-shi (JP); Toshiyuki Yamane, Yamato-shi (JP)

Correspondence Address: IBM MICROELECTRONICS;INTELLECTUAL PROPERTY LAW, 1000 RIVER STREET, 972 E, ESSEX JUNCTION, VT, 05452, US

(21) Appl. No.: 11/779,474

(22) Filed: Jul. 18, 2007

(30) Foreign Application Priority Data
Jul. 19, 2006 (JP) 2006-197177

(51) Int. Cl. G06F 11/34

(52) U.S. Cl. 714/47; 714/E11.02

(57) ABSTRACT

To efficiently detect, in an information processing system including a plurality of information processing apparatuses, an information processing apparatus in which an abnormality has occurred. For each of the information processing apparatuses, a detection apparatus stores a previously estimated average processing time per service for a plurality of services provided by the information processing apparatuses. Then, for each of the information processing apparatuses, by using communication packets acquired in a predetermined period, the detection apparatus computes the number of calling times when the services have been called, and computes a busy time, which is a total amount of time when transactions are performed. Thereafter, the detection apparatus judges that an abnormality has occurred in each of the information processing apparatuses, if a point corresponding to coordinate values indicated by the computed number of calling times and busy time deviates, beyond a predetermined criterion from a hyperplane indicated by the previously estimated average processing time per service, in a multidimensional space formed by coordinate axes indicating the number of calling times per service and also by a coordinate axis indicating the busy time.

### CROSS REFERENCES TO RELATED APPLICATIONS

This application is related to Japan Patent Application No. 2006-197177, filed Jul. 19, 2006.

### FIELD OF THE INVENTION

The present invention relates to a method for detecting an information processing apparatus in which an abnormality has occurred. In particular, the present invention relates to a method for detecting, from among numerous information processing apparatuses included in an information processing system, an information processing apparatus in which an abnormality has occurred.

### BACKGROUND OF THE INVENTION

An information system in recent years may occasionally be composed of several hundreds of computers and network apparatuses. Additionally, each of the computers has various application programs operating thereon, and operating cooperatively with application programs operating on the other computers. In such a complicated information system, troubles can be caused by various reasons. Those reasons extend to a wide range of various components of the system including hardware, middleware and application programs. The reasons may be: a failure of a storage device, a failure of a network apparatus and the like in hardware; a configuration error, a bug and the like in middleware; and a bug, an abnormality of a parameter and the like in application programs. It is often the case that it is difficult to specify a location causing an abnormality out of such various possible locations.

In response to this problem, heretofore, techniques for specifying a location causing a performance trouble have been proposed (refer to “Method of Detecting Bottleneck in Web System Based on Ascending-order Search of Directed Graph—Implementation as Performance Integrated Analysis Tool—” (Junya Shimizu et al., ProVISION, 44, 2005), and Japanese Patent Application Publication Laid-open Nos. 2003-140928 and 2005-278079). “Method of Detecting Bottleneck in Web System Based on Ascending-order Search of Directed Graph—Implementation as Performance Integrated Analysis Tool—” (Junya Shimizu et al., ProVISION, 44, 2005) describes a technique of automatically specifying, based on a knowledge base, a location causing a performance trouble all over an entire web system. More specifically, according to this technique, when information indicating a symptom is inputted, an inference result for the location causing the performance trouble is outputted on the basis of predetermined inference rules. This technique is expected to effectively operate in a case where the inference rules can be strengthened with numerous case examples. Japanese Patent Application Publication Laid-open No. 2003-140928 is a technique for specifying a method (a write unit/an execution unit in processing in the Java® language and the like) which is consuming a CPU resource the most in an application program. Additionally, the technique of Japanese Patent Application Publication Laid-open No. 2005-278079 describes a technique for detecting a resource which is being a bottleneck in a network apparatus. Moreover, as another technique, an operation monitoring application program appended to an operating system has been utilized in conventional trouble detection.

However, “Method of Detecting Bottleneck in Web System Based on Ascending-order Search of Directed Graph—Implementation as Performance Integrated Analysis Tool—” (Junya Shimizu et al., ProVISION, 44, 2005) is often ineffective in the solution of a complicated problem such as trouble detection in an information system. More specifically, causes of troubles extend to a wide range including hardware, middleware and application programs, so that it is difficult to produce effective inference rules with respect to all of these causes. Furthermore, it is also difficult to apply inference rules, which are produced for a certain field, to rules in another field. Additionally, there may not be general inference rules for inferring, based on a symptom, a location causing a trouble, from the beginning, and therefore effective inferences rules sometimes cannot be derived even with numerous case examples.

On the other hand, a method or a component which may be a bottleneck in performance may be detected by using the techniques of Japanese Patent Application Publication Laid-open Nos. 2003-140928 and 2005-278079. However, a method consuming a CPU resource may be using the CPU resource as effectively as possible in some cases, and cannot be always considered as being a bottleneck in performance. Furthermore, with these techniques, causes of troubles except for bugs in application programs cannot be effectively detected. Additionally, while the operation monitoring application program appended to an operating system is capable of detecting a trouble having occurred in a single information processing apparatus, it is not suitable for the purpose of detecting, from among numerous information processing apparatuses, an information processing apparatus in which a trouble has occurred. Moreover, use of the operation monitoring application program is not practical because execution itself of the program, and processing of collecting monitoring results therefrom lead to increase of processing load on the information system, and therefore become hindrance to regular operations.

### SUMMARY OF THE INVENTION

Consequently, an object of the present invention is to provide a detection apparatus, a program and a detection method which are capable of solving the abovementioned problems. In order to solve the abovementioned problem, provided in the present invention is a detection apparatus for detecting, in an information processing system provided with a plurality of information processing apparatuses, one information processing apparatus in which an abnormality has occurred, the detection apparatus including:

a storage unit for storing, for each of the information processing apparatuses, an average processing time per service previously estimated with respect to a plurality of services provided by the information processing apparatus;

an acquisition unit for acquiring a plurality of communication packets mutually transmitted and received among the plurality of information processing apparatuses during a period subject to detection of an abnormality;

a number-of-times computing unit for computing for each service, based on the acquired plurality of communication packets, for each of the information processing apparatuses, the number of calling times when a service provided by the information processing apparatuses is called by other information processing apparatuses;

a busy time computing unit for computing a busy time which is a total amount of time when transactions, which are processing of services, are executed for each of the information processing apparatuses;

a deviation judging unit for judging for each of the information processing apparatuses whether, in a multidimensional space formed by coordinate axes indicating the number of calling times for the respective services and also by a coordinate axis indicating the busy time, a point corresponding to coordinate values indicated by the computed number of calling time and the computed busy time is deviating, beyond a predetermined criterion, from a hyperplane indicated by the average processing time per service; and

an output unit for, by assuming one of the information processing apparatuses with respect to which the point corresponding to the coordinate values has been judged as deviating from the hyperplane beyond the predetermined criterion to be the information processing apparatus in which an abnormality has occurred during the subject period, outputting information indicating the one of the information processing apparatus.

Additionally, a program causing a computer to function as the detection apparatus, and a detection method by which an abnormality is detected by using the detection apparatus, are provided.

According to the present invention, a location causing an abnormality having occurred in an information processing system can be effectively detected.

### BRIEF DESCRIPTION OF THE DRAWINGS

FIG. 1 shows a configuration of an information processing system, and a connection relation between the information processing system and a detection apparatus.

FIG. 2 shows a functional configuration of the detection apparatus.

FIG. 3 shows one example of processing in which the detection apparatus detects a location causing an abnormality.

FIG. 4a is a conceptual diagram of processing of computing a busy time.

FIG. 4b shows a specific example of the processing of computing the busy time.

FIG. 5 shows a specific example of a hyperplane indicated by an average processing time per service.

FIG. 6 shows a relation between the number of calling times for each service and the busy time.

FIG. 7a shows how an average processing time for each service changed as time elapsed.

FIG. 7b shows how a residual of estimated values for the average processing time per service changed as time elapsed.

FIG. 8 shows another example of processing in which the detection apparatus detects a location causing an abnormality.

FIG. 9 shows one example of a hardware configuration of a computer which functions as the detection apparatus.

### DETAILED DESCRIPTION

Although the present invention will be described below by way of the best mode for carrying out the invention (hereinafter, referred to as the embodiment), the following embodiment does not limit the invention according to the scope of claims, and all of combination of characteristics described in the embodiment may not necessarily be essential for the solving means of the invention.

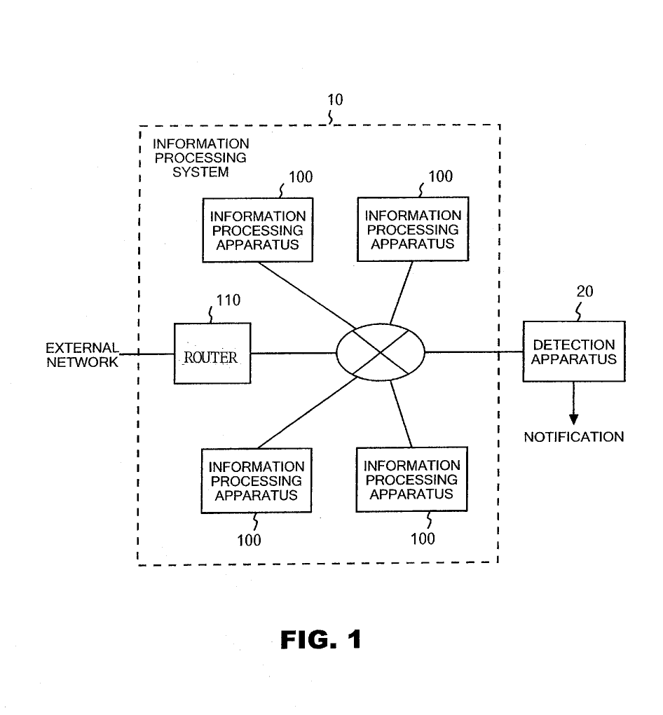

FIG. 1 shows a configuration of an information processing system 10, and a connection relation between the information processing system 10 and a detection apparatus 20. The information processing system 10 is provided with a plurality of information processing apparatuses 100 and a router 110. The plurality of information processing apparatuses 100 provide services to one another. For example, when one of the information processing apparatuses 100, which is a web server, accepts a request for a web page through the router 110 from an external network, it requests another one of the information processing apparatuses 100, which is an application server, to perform processing necessary for generating contents of the web page. The information processing apparatus 100 being the application server requests data necessary for executing an application for other information processing apparatuses 100 which is a data base server. When the information processing apparatus 100 being the application server receives supply of data from the information processing apparatus 100 being the data base server, it completes execution of a program by using the data, and returns a result of the execution to the information processing apparatus 100 being the web server. The information processing apparatus 100 being the web server generates the web page based on the execution result, and returns the web page to a terminal apparatus on the external network. Thus, the information processing system 10 functions as one web system by having the plurality of information processing apparatuses 100 operate cooperatively with one another.

The detection apparatus 20 according to this embodiment is intended to detect, from among the plurality of information processing apparatuses 100 included in the information processing system 10, an information processing apparatus 100 in which an abnormality has occurred. Thereby, even in a case where it is difficult to search a cause of occurrence of the abnormality because an internal configuration of the information processing system 10 is complicated, where the occurrence of the abnormality is located can be made known, and problem solution can be expedited.

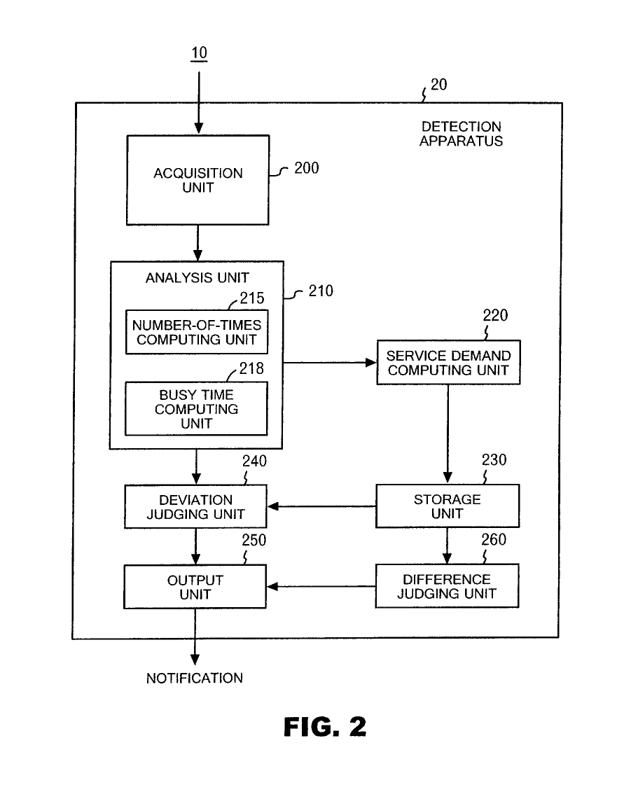

FIG. 2 shows a functional configuration of the detection apparatus 20. The detection apparatus 20 includes an acquisition unit 200, an analysis unit 210, a service demand computing unit 220, a storage unit 230, a deviation judging unit 240, an output unit 250, and a difference judging unit 260. With reference to this drawing, description will be given for two processing examples of a case where an abnormality having occurred in the information processing system 10 is detected by the detection apparatus 20.

### FIRST PROCESSING EXAMPLE

The acquisition unit 200 acquires a plurality of communication packets mutually transmitted and received among the respective information processing apparatuses 100 in a predetermined trial period preceding a period subject to detection of an abnormality. As one example, by acquiring replicated data of communication packets, which are transferred through a communication line within the information processing system 10, from a communication apparatus connected to the communication line, and additionally by executing, for example, a tcpdump command of a UNIX® based operating system, the acquisition unit 200 may generate dump data of the replicated data. Note that it is desirable that this trial period be a period in which no abnormality is occurring in the information processing system 10.

The analysis unit 210 analyzes contents of the communication packets in order to compute an average processing time per service under a normal condition. Specifically, the analysis unit 210 includes a number-of-times computing unit 215 and a busy time computing unit 218. For each of divided periods obtained by dividing the trial period, by using the communication packets having been acquired during the each of the divided periods, the number-of-times computing unit 215 computes, for each of the information processing apparatuses 100 and for each service, the number of calling times when the each service of the information processing apparatuses 100 has been called from other information processing apparatuses 100. For example, whether or not each of the communication packets acquired during each of the divided periods is a communication packet for calling a service is judged by the number-of-times computing unit 215 based on any one of a destination address URL or identification information of the service which are contained in the communication packets, and the number of the communication packets for calling each of the services is computed as the number of calling times for the each of the services by the number-of-times computing unit 215.

Additionally, in each of the divided periods, based on the communication packets acquired during each of the divided periods, the busy time computing unit 218 computes a busy time which is a total amount of time when each of the information processing apparatuses 100 executes transactions. Specifically, the busy time computing unit 218 judges, as an in-processing time period when the each of the information processing apparatuses 100 is processing transactions, a period from when the communication packet for calling any service provided by the information processing apparatuses 100 is acquired to when communication packets for returning processing results for the respective service have been acquired, and computes a length of the in-processing time period as a busy time. In order to more accurately compute the busy time, the busy time computing unit 218 may exclude a predetermined processing wait time period from the in-processing time period. This point will be described later in detail.

For each of the information processing apparatuses 100, the service demand computing unit 220 computes an average processing time per service which minimizes an index indicating a difference between the busy time in each of the divided periods, and a sum of products obtained by multiplying the number of calling times for each service by average processing times of transactions for processing the services in the each of the divided period. Specifically, this index may be a sum of squares of the difference in each of the divided periods. To be more precise, the service demand computing unit 220 generates a normal equation for finding an average processing time per service that minimizes a sum of squares of the differences in the respective divided periods.

Furthermore, with respect to each of the information processing apparatuses 100, the service demand computing unit 220 may compute, in each of the divided periods, a difference between the busy time and a sum of products obtained by multiplying the number of calling times for services respectively by average processing times of transactions processing the services, and compute a variance of the differences in the respective divided periods. For each of the information processing apparatuses 100, the storage unit 230 stores therein the thus computed average processing time per service as previously estimated average processing time per service, and, in addition, stores therein the thus computed variance.

After the trial period has elapsed, in the subject period subjected to detection of an abnormality, the acquisition unit 200 acquires a plurality of communication packets mutually transmitted and received among the information processing apparatuses 100. Based on the plurality of communication packets having been acquired, for each of the information processing apparatuses 100, the number-of-times computing unit 215 computes, for each service, the number of calling times when the each service provided by the information processing apparatuses 100 has been called from other information processing apparatuses 100. The busy time computing unit 218 computes a busy time which is a total amount of time when each of the information processing apparatuses 100 executes transactions which are processing of services. Specific examples of the respective processing are the same as the case with the divided periods.

Here, consider a multidimensional space formed by coordinate axis indicating the number of calling times for each service and a coordinate axis indicating the busy time, coordinate values indicated by the number of calling times and the busy times which are computed in a subject period, and a hyperplane indicated by the average processing times per service which is previously estimated in a trial period. With respect to each of the information processing apparatuses 100, the deviation judging unit 240 judges whether or not the point indicated by the coordinate values deviate from a hyperplane beyond a predetermined criterion. Then, as an information processing apparatus in which an abnormality has occurred, the output unit 250 regards the information processing apparatus that has been judged as having the coordinate values whose point deviates from the hyperplane beyond the predetermined criterion, and output indicating the foregoing information processing apparatuses. Thereby, a user can specify an information processing apparatus which is providing a service taking a particularly longer time than that under a normal condition.

### SECOND PROCESSING EXAMPLE

In this processing example, detection of an abnormality is started without providing the trial period. First of all, the acquisition unit 200 acquires a plurality of communication packets mutually transmitted and received among the information processing apparatuses 100 in each of the plural subject periods which sequentially elapse. Every time each of the subject periods elapses, based on the communication packets having been acquired during the subject periods, the number-of-times computing unit 215 computes, for each of the information processing apparatuses 100 and for each service, the number of calling times for the each service. Furthermore, every time each of the subject periods elapses, based on the communication packets having been acquired during the each of the subject periods, the busy time computing unit 218 computes the busy time for each of the information processing apparatuses 100. Every time each of the subject periods elapses, based on the plurality of communication packets having been acquired in all of the elapsed subject periods, the service demand computing unit 220 computes the average processing time per service in each of the information processing apparatuses 100, and stores it in the storage unit 230 as an estimated value of the average processing time per service. The average processing time per service can be computed by applying the process of minimizing a sum of squares of the above described differences with the plural subject periods being assumed as the plural divided periods.

Additionally, when one of the subjected periods has elapsed, the number-of-times computing unit 215 computes, based on a plurality of communication packets having been acquired during this current subject period, the number of calling times for each service and for each of the information processing apparatuses 100. Moreover, based on the plurality of communication packets having been acquired during the current subject period, the busy time computing unit 218 computes the busy time for each of the information processing apparatuses 100. Then, the deviation judging unit 240 judges whether, in a multidimensional space formed by coordinate axis indicating the number of calling times for the respective services and a coordinate axis indicating the busy time, a point corresponding to coordinate values indicated by the number of calling time and the busy time which have been computed in the current subject period is deviating, beyond a predetermined criterion, from a hyperplane indicated by the previously estimated average processing time per service which has been stored in the storage unit 230. By assuming any one of the information processing apparatuses 100 with respect to which the point corresponding to the coordinate values has been judged as deviating from the hyperplane beyond the predetermined criterion to be the information processing apparatus 100 in which an abnormality has occurred, the output unit 250 outputs information indicating the foregoing information processing apparatuses.

Furthermore, in this second processing example, every time the average processing time per service is computed by the service demand computing unit 220, the difference judging unit 260 judges, for each of the information processing apparatuses 100, whether the average processing time per service having been computed immediately before differs, from the currently computed average processing time per service beyond a predetermined criterion. Then, also for any one of the other information apparatuses 100 with respect to which the points corresponding to the coordinate values have been judged as not deviating from the hyperplane, on condition that the foregoing average processing times differ from each other beyond the predetermined criterion, the output unit 250 outputs information indicating the foregoing one of the information processing apparatuses 100 by assuming the foregoing one of the information processing apparatuses 100 to be the information processing apparatus 100 in which an abnormality has occurred in the current subject period. This is performed for the purpose of adequately detecting occurrence of an abnormality even in a case where, after the average processing time per service has been changed, an estimated value thereof is computed immediately in accordance with the change. More specifically, in the case where, after the average processing time per service has been changed, an estimated value thereof is computed immediately in accordance with the change, the hyperplane described in the multidimensional space comes to be immediately changed by the estimated value. In this case, although some abnormality is suspected because of the change of the average processing time per service, the point corresponding to the coordinate values indicated by the observed number of calling times and busy time does not diverge from the hyperplane, and the abnormality cannot be detected by the deviation judging unit 240. In this embodiment, an abnormality of this kind can be detected in a manner allowing the difference judging unit 260 to detect a change in the average processing time per service itself.

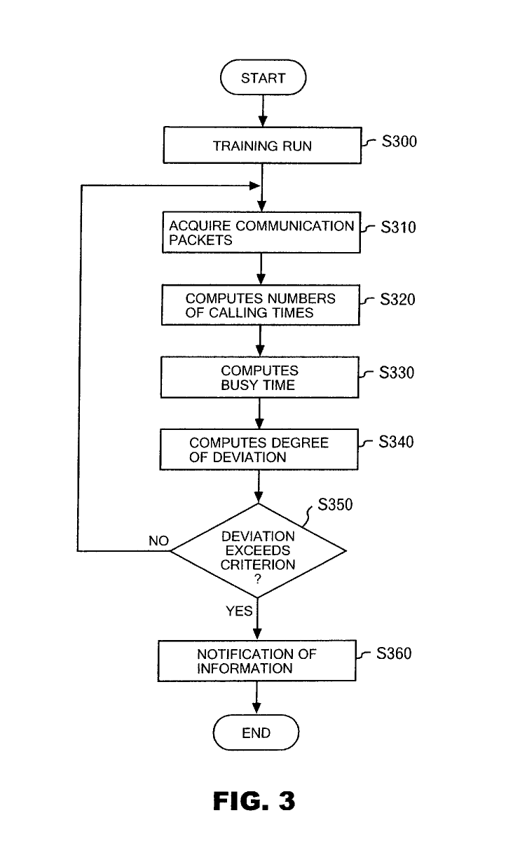

FIG. 3 shows one example of processing in which the detection apparatus 20 detects a location causing an abnormality. With reference to FIGS. 3 to 5, details of the abovementioned first processing example will be described. First of all, the detection unit 20 acquires communication packets during the trial period, and then analyzes them in order to compute an estimated value of the average processing time per service under a normal condition (S300). Hereafter, this processing will be referred to as a training run. Specifically, in each of the divided periods, the detection unit 215 computes, for each of the information processing apparatuses 100 and for each service, the number of calling times when the each of the information processing apparatuses 100 has been called for each service by the other information processing apparatuses 100. Additionally, in each of the divided periods, the busy time computing unit 218 computes the busy time for each of the information processing apparatuses 100. Each of the divided periods will be referred to as a period j by appending thereto a suffix indicating an index j. The period j is defined, for example, by the following expression (1), where 1≦j≦m.

$$[ T + {\sum }_{t = 1}^{j - 1} Δ {T}_{t} , T + {\sum }_{t = 1}^{j} Δ {T}_{t} ] \qquad ( 1 )$$

Each of the information processing apparatuses 100 will be indicated by an index k, and each of the services will be indicated by an index i. Based on these definitions, the busy time of the information processing apparatus k in the divided period j will be denoted as bⱼₖ. Additionally, the number of calling times for the service i provided by the information processing apparatus k will be denoted as aⱼᵢₖ. Additionally, the average processing time for the service i provided by the information processing apparatus k will be denoted as dᵢₖ. A relation expressed by the following equation (2) holds among them.

$${b}_{jk} = {\sum }_{i} {a}_{jik} {d}_{ik} + {ɛ}_{jk} \qquad ( 2 )$$

Note that εⱼₖ indicates an observation error of the busy time and the number of calling times for the information processing apparatus k in the divided period j. The service demand computing unit 220 computes, for each of the information processing apparatuses, the average processing time per service which minimizes a sum of squares of these observation errors. That is, for each of the information systems, the service demand computing unit 220 computes dᵢₖ, i.e., the estimated value of the average processing time per service by generating and solving a normal equation with respect to m simultaneous linear equations assuming dᵢₖ and εⱼₖ as unknowns, the normal equation computing dᵢₖ and minimizing the sum of squares of εⱼₖ.

Furthermore, the service demand computing unit 220 may compute, for each of the information processing apparatuses 100, a difference between the busy time and a sum of products obtained by multiplying the average processing times for service respectively by the number of calling times for the services, and compute a variance of the differences. Processing of this computation can be expressed as the following equation (3). Note that the average processing time per service estimated in the training run will be indicated by appending ̂ to dᵢₖ.

$${\hat{σ}}_{k}^{2} = {\sum }_{j = 1}^{m} {( {b}_{jk} - {\sum }_{i} {a}_{jik} {\hat{d}}_{ik} )}^{2} / m \qquad ( 3 )$$

Next, the acquisition unit 200 acquires, for each of the predetermined subject periods, communication packets transferred in the each of the predetermined subject periods within the information processing system 10 (S310). It is desirable that, by configuring the communication packet to be acquired through such means as a mirror port of a switching hub provided in the information processing system 10, actual communications within the information processing system 10 be made unsusceptible by the acquisition. Subsequently, based on the acquired plural communication packets, for each of the information processing apparatuses 100, the number-of-times computing unit 215 computes for each service the number of calling times when a service provided by the information processing apparatuses 100 has been called by other information processing apparatuses 100 (S320).

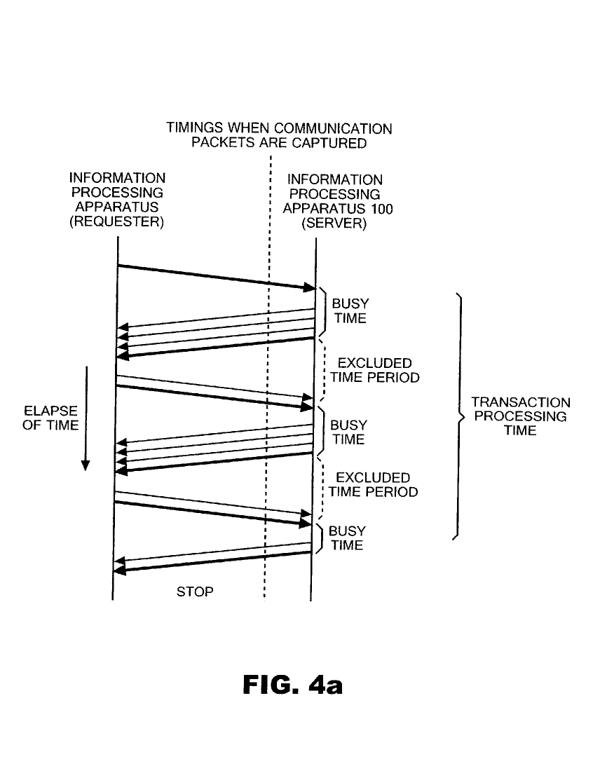

Next, based on the communication packets having been acquired during the each of the subject periods, for each of the information processing apparatuses 100, the busy time computing unit 218 computes the busy time which is a total amount of time when transactions, which are processing of services, are executed (S330). A specific example of the computation is shown in FIGS. 4a and 4b.

FIG. 4a is a conceptual diagram of the processing of computing the busy time. First of all, for each of combinations of transmission sources and destinations of the communication packets, the busy time computing unit 218 selects a finally transmitted communication packet from among a plurality of communication packets continuously transmitted in the same direction. This is because, when a large size data is transmitted in a state being divided into a plurality of communication packets, these communication packets are considered as a single communication. In FIG. 4a, a communication flow of the selected communication packet is indicated by a heavy line. Based on this selected communication packet, the busy time computing unit 218 determines the busy time in the following manner.

Suppose that only one service is provided by a certain one (referred to as a server) of the information processing apparatuses 100. When that one of the information processing apparatuses 100 receives from another one (referred to as a requester) of the information processing apparatuses a communication packet requesting the service, the busy time computing unit 218 judges a clock time when the communication packet has been transferred to be a starting clock time of the busy time. Furthermore, when a result of processing of the service is returned by the server to the requester in response to the request, the busy time computing unit 218 judges a clock time at that time to be an ending clock time of the busy time.

However, there is a case where, during processing of a transaction thereof, the server returns a confirmation-purpose communication packet to the requester. In this case, the server suspends the transaction for a period thereafter until confirmation responding to the confirmation-purpose communication packet is returned. This period for which the transaction is suspended is a period which occurs because a transmission waiting state of communication packets has occurred or because communication delay has occurred in a communication path. For this reason, this period should not be included in the busy time because the server is not performing the processing of the service during this period. More specifically, if this period is included in the busy time in the server, the busy time in the server becomes longer than usual even when the processing is delayed because of occurrence of an abnormality in the information processing apparatus 100 working as the requester. To be more specific, there is a case where, even when an abnormality has occurred in the information processing apparatus working as the requester, the deviation judging unit 240 judges that an abnormality has occurred in the server. Other than the confirmation-purpose communication packet, there is also a case where a packet for handshake of SSL, or the like, is sent out to the requester.

For this reason, even if a certain period is within a period from when any one of the services has been called to when results of processing for the respective services have been returned, the busy time computing unit 218 excludes the certain period from the busy time if the certain period is a period when, after communication packet corresponding to the respective services currently being processed has been transmitted to other information processing apparatuses 100, communication packets responding thereto have not yet been returned (the requester in the case of FIG. 4a). In FIG. 4b, processing of this exclusion will be described further in detail.

FIG. 4b shows a specific example of the processing of computing the busy time. In the example of FIG. 4b, a certain one (referred to as a requester 1) of the information processing apparatuses 100, which requests a service, requests a transaction 1 from another one (referred to as a server) of the information processing apparatuses 100 which provides the service, the transaction 1 being processing of the service. At this point, the number of transactions that should be processed in the server is one. Subsequently, still another one (referred to as a requester 2) of the information processing apparatuses 100 requests another transaction 2 from the server, the transaction 2 being processing of the service. As a result, the number of transactions that should be processed in the server becomes two.

During execution of the transaction 1, the server returns a confirmation-purpose communication packet to the requester 1. At this point, while the number of transactions being executed in the server remains two, the transaction 1 out of these transactions goes into a processing wait state. Such a confirmation-purpose communication packet should be transmitted, for example, in compliance with specifications of a communication protocol, and is not needed in processing an application program providing a service. Accordingly, the number of transactions including those in the processing wait state will be referred to as the number of transactions at the application level, and the number of transactions excluding those in the processing wait state will be referred to as the number of transactions at the protocol level. That is, the number of transactions at the application level is two, and the number of transactions at the protocol level is one.

Subsequently, during execution of the transaction 2, the server returns a confirmation-purpose communication packet to the requester 2. At this point, while the number of transactions being executed in the server remains two, all of these transactions go into the processing wait state. Accordingly, the number of transactions at the application level is two, and the number of transactions at the protocol level is zero. Subsequently, a reply responding to the confirmation-purpose communication packet is transmitted to the server from the requester 1. As a result, the transaction 1 is restarted in the server. Thereby, the number of transactions at the protocol level returns to 1. Furthermore, a reply responding to the confirmation-purpose communication packet is transmitted to the server from the requester 2. As a result, the transaction 2 is restarted in the server. Moreover, the number of transaction at the protocol level returns to two.

In order to detect such a change in a communication state, the busy time computing unit 218 includes, for each of the information processing apparatuses 100, a counter for storing therein the number of transactions at the protocol level. In addition, the busy time computing unit 218 performs the following processing for each of the information processing apparatuses 100. First of all, when the busy time computing unit 218 acquires a communication packet for calling any one of the services provided by the information processing apparatuses 100, it increments the counter corresponding to that information processing apparatus 100. Additionally, when the busy time computing unit 218 acquires a communication packet through which a result of processing of any one of the services provided by that information processing apparatus 100 is returned by that information processing apparatus 100, it decrements the counter. Thereby, the number of transactions at the application level is managed as a counter value.

Furthermore, on condition that the counter value is at least 1, the busy time computing unit 218 decrements the counter value when a confirmation-purpose communication packet is transmitted from the information processing apparatus 100 to other information processing apparatuses 100. Additionally, the busy time computing unit 218 increments the counter value when a reply responding to a confirmation-purpose communication packet is transmitted to that information processing apparatus 100 from another one of the information processing apparatuses 100. Thereby, the number of transactions at the protocol level is managed as the counter value. The busy time computing unit 218 determines, as a busy time at the application level, a period between a clock time when the counter value has changed from 0 to 1, and a clock time when the counter value has changed from 1 to 0. Then, the busy time computing unit 218 excludes, from the busy time at the application level, a time period when the counter value has been 0. A busy time computed as a result of this computation becomes a busy time at the protocol level.

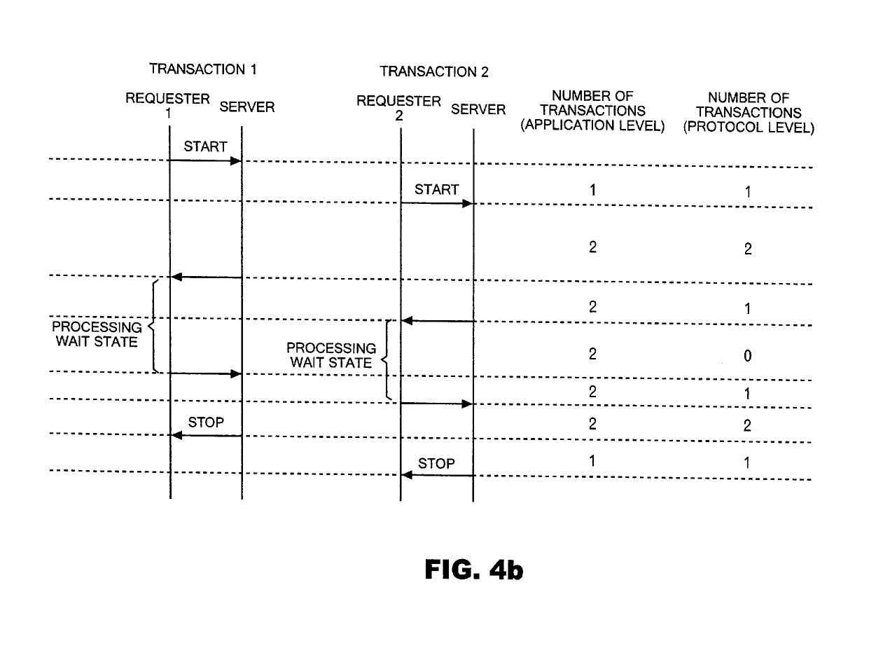

FIG. 3 will be referred to again. Subsequently, the deviation judging unit 240 judges, for each of the information processing apparatuses 100, whether the number of calling times and the busy time which have been computed for each of the subject periods diverge from the average processing time per service found based on the number of calling times and based on the busy time which have been observed in the training run (S340). This processing is performed by applying thereto a method such as residual analysis. A conceptual diagram thereof is shown in FIG. 5.

FIG. 5 shows a specific example of the hyperplane indicated by the average processing time per service. With reference to FIG. 5, description will be given of a case where services provided by a certain one of the information processing apparatuses 100 are only a₁ and a₂. In a case where, the average processing times for the services a₁ and a₂ are 1 unit time and 2 unit times respectively under a normal condition, the following equation (4) holds when the busy time is denoted as b. In FIG. 5, a three-dimensional space having the number of calling times for the services a₁ and a₂, and the busy time respectively set as coordinate axes is shown. Additionally, a plane indicated by the average processing time per service having been estimated in the training run, i.e., a plane expressed by the equation (4) is shown. On the plane and in the neighborhood of the plane, points corresponding to coordinate values indicating the number of calling times and the busy times which have been observed during the respective divided periods included in the training run are plotted.

b=a₁+2a₂ (4)

Note that, when equation (4) is generalized into a case where n various services from a service aₙ to a service aₙ exist, observation values for the number of calling times and the busy time are expressed as coordinate values indicated by the following expression (5). Here, points corresponding to these coordinate values in the n+1 dimension space come to be distributed in the neighborhood of a hyperplane indicated by the average processing time for each service.

∃k∀(aⱼ₁ₖ, aⱼ₂ₖ, . . . aⱼₙₖ, bⱼₖ) (5)

The deviation judging unit 240 judges whether a point corresponding to coordinate values indicated by the number of calling times and busy time which have been newly computed in the subject period is deviating from this plane beyond a predetermined criterion. For example, five points of coordinate values in an upper part of FIG. 5 are deviating from this plane beyond the predetermined criterion. As one example of a deviation judging method, the deviation judging unit 240 may compute, in the subject period, a difference between the busy time and a sum of products obtained by multiplying the average processing times for service respectively by the number of calling times for the services. A computation formula therefor is, for example, as expressed by the following equation (6), and this difference will be referred to as a residual in the following description.

rⱼₖ=bⱼₖ−Σᵢαⱼᵢₖ\hat{d}ᵢₖ (6)

FIG. 3 will be referred to again. Subsequently, the deviation judging unit 240 judges, for each of the information processing apparatuses 100, whether a point corresponding to coordinate values expressed by the number of calling times and the busy time which have been computed by the analysis unit 210 is deviating, beyond a predetermined criterion, from the hyperplane indicated by the previously estimated average processing time per service (S350). Specifically, the deviation judging unit 240 judges whether the residual computed by equation (6) is larger by at least a predetermined value than the variance having been estimated for the each of the information processing apparatuses 100 in the training run, and having been stored in the storage unit 230. For example, the deviation judging unit 240 may judge whether the residual is at least three times as large as the variance (inequality (7)). Then, on condition that the residual is larger by at least the predetermined value than the variance, the deviation computing unit 240 judges that the point corresponding to the coordinate values indicating the busy time and the like in the subject period is deviating from the plane indicating the average processing time per service having been estimated in the training run.

|rⱼₖ|>3×\hat{σ}ₖ (7)

Alternatively, the deviation judging unit 240 may compute the residual indicated in equation (6) plural times in the subject period, and judge, based on whether or not these residuals follow a predetermined distribution, whether the point corresponding to the coordinate values is deviating from the plane. The predetermined distribution is, for example, a normal distribution, and follows equations (8).

[symbol]

r_{pq} [symbol] =0, [symbol] _{pq}r_{rq} [symbol] =\hat{σ}_{q}²δₚᵣ, N(0,\hat{σ}_{q}²) (8)

Note that: < > denotes an ensemble average; δₚᵣ, a Kronecker delta; and σ_{q} to which ̂ is appended, a standard deviation of estimated errors in the information processing apparatus q. The deviation judging unit 240 may judge, for example, by use of a statistical method such as hypothesis testing, to what degree the plural residuals computed by equation (6) in the subject period follow the distribution of r indicated by equation (8). Thereby, how much distributed the coordinate values of the busy time and the like which have been newly computed are about the hyperplane shown in FIG. 5 can be found. Note that the deviation judgment method used by the deviation judging unit 240 is not limited to these methods. For example, the deviation judging unit 240 may compute a distance from the hyperplane indicated by the average processing time per service having been previously estimated in the training run to the point corresponding to the coordinate values indicated by the busy time and the number of calling times which have been computed in the subject period, and judge whether or not the distance exceed a predetermined length. Thus, as long as a degree of deviation from the hyperplane to the point corresponding to the coordinate values can be judged by the deviation judging method, details of the method are no object.

Subsequently, the output unit 250 makes judgment on whether or nor an abnormality has occurred in each of the information processing apparatuses 100 (S350). Specifically, the output unit 250 outputs information indicating the each of the information processing apparatuses 100 (S360) on condition that, for that information processing apparatus 100, the point corresponding to the coordinate values expressed by the number of calling times and the busy time which have been computed by the analysis unit 210 is deviating, beyond the predetermined criterion, from the hyperplane indicated by the previously estimated average processing time per service (YES in S350). Note that, if the number of times when the point corresponding to the coordinate values has diverged from the hyperplane beyond the predetermined criterion is only one, the output unit 250 may judge that an abnormality has not occurred. For example, the output unit 250 outputs information indicating the each of the information processing apparatuses 100 (S360) on condition that the number of times when the point corresponding to the coordinate values has diverged from the hyperplane beyond the predetermined criterion has reached a predetermined criterion (for example, three). Thereby, accuracy of abnormality detection can be enhanced by excluding, from cases subjected to the detection, a case where an abnormal one of the busy times has been observed due to an observation error or a loss of a communication packet. On condition that the point corresponding to the coordinate values is not deviating beyond the predetermined criterion (NO in S350), the detection apparatus 20 sets the processing back to S310 and makes the judgment in the succeeding subject periods.

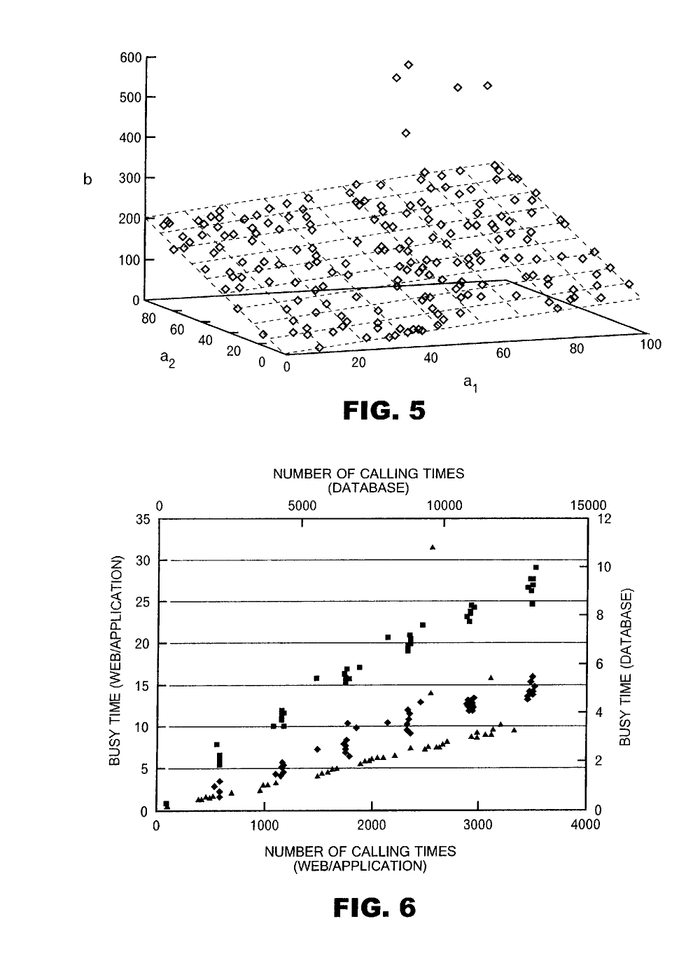

Next, with reference to FIGS. 6 to 8, results of an experiment in which the detection apparatus 20 according to this embodiment was applied to the information processing system 10 simulating an actual operation system. In this experiment, the information processing system 10 included three of the information processing apparatuses 100, which were assumed to be a web server, an application server, and a database server, respectively. Additionally, it was assumed that each of these information processing apparatuses 100 was providing one service.

FIG. 6 shows a relation between the number of calling times for each service and the busy time. Diamond marks indicate the service of the web server, square marks indicate the service of the application server, and triangle marks indicate the service of the database server. A horizontal axis in the upper side of the graph indicates the number of calling times for the service of the database server, and a horizontal axis in the lower side thereof indicates the number of calling times for the services of the web server and the application server. Further, a vertical axis in the right side thereof indicates the busy time (in units of milliseconds, which will be the same hereinafter) for the service of the database server, and a vertical axis in the left part thereof indicates the number of calling times for the services of the web server and the application server.

In FIG. 6, there is shown a relation between the number of calling times for each service and the busy time, which were observed when degrees of concentration of requests for the each service which were transmitted to the information processing system 10, were changed. It can be found that, when the degrees of concentration were changed, a ratio of the number of calling times to the busy time was substantially constant although the number of calling times and the busy time changed. To be more precise, it is confirmed that the average processing time per service does not depend on the degree of concentration of requests for a service, and is invariable.

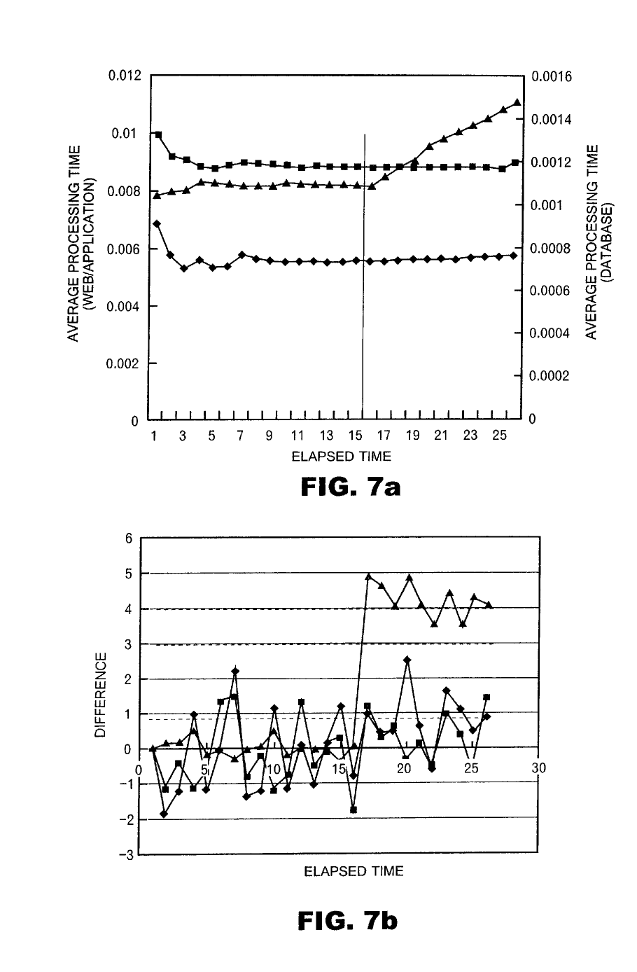

FIG. 7a shows how the average processing time for each service changed as time elapsed. A horizontal axis thereof indicates an elapsed time (in units of minutes), and a vertical axis thereof indicates estimated values for the average processing time for each service. When a simulated abnormality was caused in the database server after 16 minutes had elapsed since the start of the experiment, the estimated values for the average processing time for each service went gradually changing. A reason why the estimated values gradually change and do not immediately follow a true value is that sufficient transactions to enhance accuracy of the estimation cannot be processed in a short time period. To be more specific, while solving a normal equation for simultaneous linear equations obtained by assigning a certain number of combinations of the busy time b and the number aᵢ of calling times into equation (2) is required in finding the average processing time, a plurality of simultaneous linear equations are required in accurately finding a solution of the normal equation, the plurality of simultaneous linear equations respectively having ratios among the number aᵢ of calling times widely different with one another so as to respectively correspond to cases where transactions of the services are processed with various combination ratios. For this reason, it is rare that the number of calling times widely changes in a short time period, and it inevitably takes time for the estimated values follow the true value.

On the other hand, FIG. 7b shows how the residual of estimated values for the average processing time per service changed as time elapsed. It can be found that, when the abnormality occurred after 16 minutes had elapsed since the start of the experiment, the residual with respect to the service of the database server rapidly changed, and exceeded a predetermined value (which is, for example, three times as much as the variance) indicated by a dotted line.

As has been described above, with reference to FIG. 6, it is confirmed that, as long as an abnormality has not occurred, the average processing time per service assumes invariable values. Furthermore, with reference to FIGS. 7a and 7b, it is confirmed that occurrence of an abnormality can be quickly detected by detecting a change in the residual instead of that in the average processing time per service.

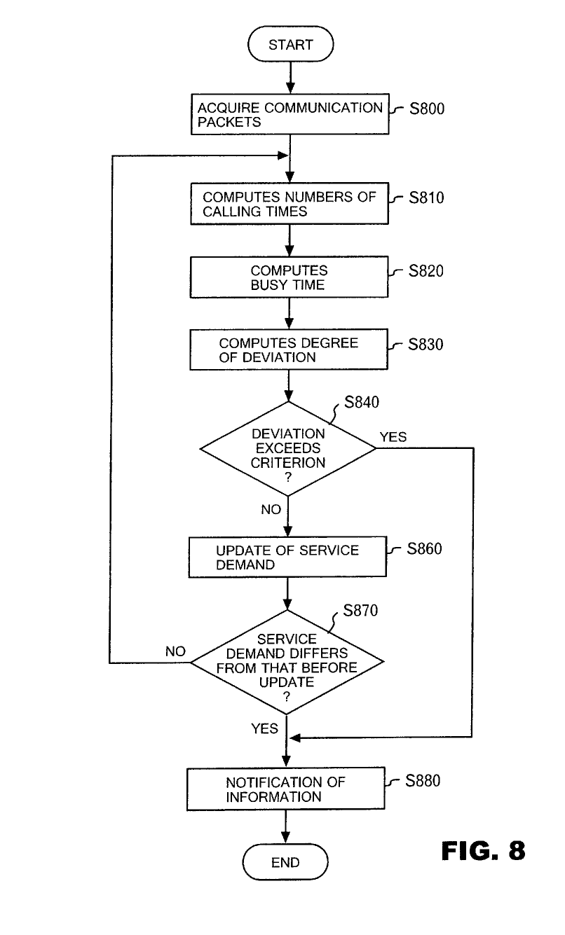

FIG. 8 shows another example of processing in which the detection apparatus 20 detects a location causing an abnormality. With reference to FIG. 8, a processing flow in the abovementioned second processing example will be described. First of all, the acquisition unit 200 acquires a plurality of communication packets mutually transmitted and received among the information processing apparatuses 100 in each of the plural subject periods which sequentially elapse (S800). Every time each of the subject periods elapses, based on the communication packets having been acquired during the each of the subject periods, the number-of-times computing unit 215 computes, for each of the information processing apparatuses 100 and for each service, the number of calling times when the each service has been called (S810). Additionally, every time each of the subject periods elapses, the busy time computing unit 218 computes, based on the communication packets having been acquired during the each of the subject periods, the busy time for each of the information processing apparatuses 100 (S820).

Next, for each of the information processing apparatuses 100, the deviation judging unit 240 computes an index value indicating to what degree, in a multidimensional space formed by the coordinate axis indicating the number of calling times for the respective services and the coordinate axis indicating the busy time, the point corresponding to coordinate values indicated by the number of calling time and the busy time which have been computed in the current subject period is deviating from the hyperplane indicated by the average processing time per service having been stored in the storage unit 230 (S830). This index value is, for example, the above described residual.

On condition that the point corresponding to the coordinate values is deviating from the hyperplane (YES in S840), the output unit 250 outputs information indicating each of the information processing apparatuses 100 (S880). On the other hand, if the point corresponding to the coordinate values is not deviating from the hyperplane (NO in S840), the service demand computing unit 220 updates the average processing time per service having been stored in the storage unit 230 (S860). To be more specific, based on the plural communication packets having been acquired in the already elapsed subject periods, the service demand computing unit 220 computes the average processing time per service in each of the information processing apparatuses 100, and stores it in the storage unit 230.

Next, the difference judging unit 260 judges, for each of the information processing apparatus 100, whether the average processing time per service having been computed immediately before differs from the currently computed average processing time per service beyond the predetermined criterion (S870). In order to detect a change in the average processing time, a conventional method called change point analysis can be applied. For example, the difference judging unit 260 may detect a change in the average processing time by using a method such as Shewhart control chart, cumulative sum control chart or geometrical moving average. If the difference is equal to or greater than the predetermined criterion (YES in S870), the output unit 250 outputs information indicating the each of the information processing apparatuses 100 (S880). On the other hand, if the difference is not equal to or greater than the predetermined criterion (NO in S870), the detection apparatus 20 sets the processing back to S800, and repeats the judgment with respect to the succeeding subject periods.

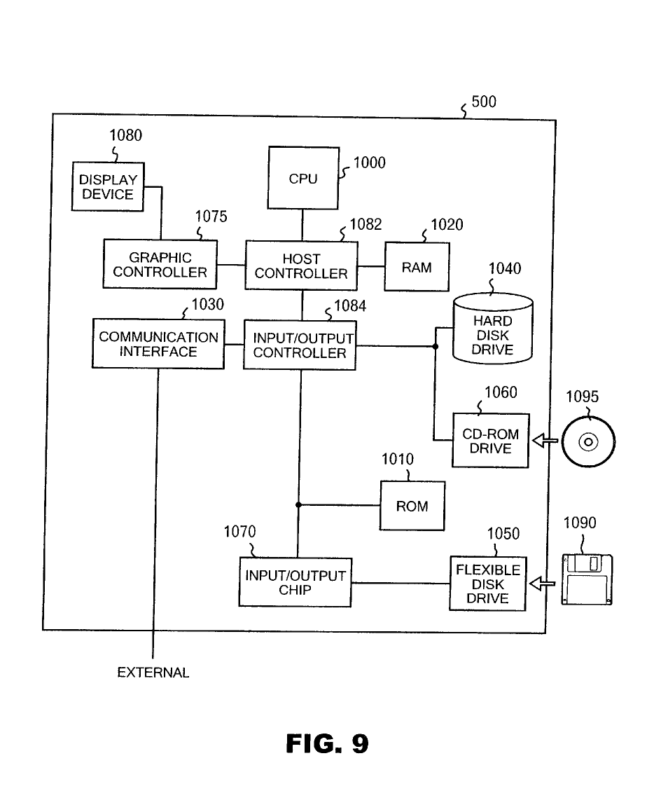

FIG. 9 shows one example of a hardware configuration of a computer 500 which functions as the detection apparatus 20. The computer 400 has: a CPU peripheral section including a CPU 1000, a RAM 1020 and a graphic controller 1075 which are mutually connected by a host controller 1082; an input/output section including a communication interface 1030, a hard disk drive 1040 and a CD-ROM drive 1060 which are connected with the host controller 1082 via an input/output controller 1084; and a legacy input/output section including a ROM 1010, a flexible disk drive 1050 and an input/output chip 1070 which are connected with the input/output controller 1084.

The host controller 1082 connects the RAM 1020 with the CPU 1000 and the graphic controller 1075 which access to the RAM 1020 at a high transfer rate. The CPU 1000 operates based on programs stored in the ROM 1010 and the RAM 1020, and controls the respective sections. The graphic controller 1075 obtains image data generated by the CPU 1000 and the like on a frame buffer provided within the RAM 1020, and displays the image data on a display device 1080. Instead of this, the graphic controller 1075 may contain therein a frame buffer for storing image data generated by the CPU 1000 and the like.

The input/output controller 1084 connects the host controller 1082 with the communication interface 1030, the hard disk drive 1040 and the CD-ROM drive 1060 which are relatively high-speed input/output devices. The communication interface 1030 communicates with an external apparatus via a network. The hard disk drive 1040 stores programs and data used by the computer 500. The CD-ROM drive 1060 reads out a program or data from a CD-ROM 1095 and supplies it to the RAM 1020 or the hard disk drive 1040.

Additionally, the relatively low-speed input/output devices including the ROM 1010, the flexible disk drive 1050 and the input/output chip 1070 are connected with the input/output controller 1084. The ROM 1010 stores: a boot program executed by the CPU 1000 at the startup of the computer 500; programs dependent on the hardware of the computer 500; and the like. The flexible disk drive 1050 reads out a program or data from the flexible disk 1090 and supplies it to the RAM 1020 or the hard disk drive 1040 via the input/output chip 1070. The input/output chip 1070 connects the various input/output devices through the flexible disk 1090, and through, for example, a parallel port, a serial port, a keyboard port and a mouse port.

A program provided to the computer 500 is stored in the flexible disk 1090, the CD-ROM 1095 or a recording medium such as an IC card, and is provided by the user. The program is read from the recording medium through at least any one of the input/output chip 1070 and the input/output controller 1084, and is installed in the computer 500 to be executed. Operations which the program causes the computer 500 and the like to execute are the same with those in the detection apparatus 20 which have been described in connection with FIGS. 1 to 8, and therefore, description thereof will be omitted.

The program described above may be stored in an external recording medium. As the recording medium, any one of an optical recording medium such as a DVD and a PD, a magneto-optic recording medium such as an MD, a tape medium, a semiconductor memory such as an IC card, and the like may be used other than the flexible disk 1090 and the CD-ROM 1095. Additionally, the program may be supplied to the computer 500 via the network by using as the recording medium a storage device such as a hard disk and a RAM provided in a server system connected with a dedicated communication network or the Internet.

As has been described above, according to the detection apparatus 20, even in the complicated information processing system 10 where a large number of the information processing apparatuses 100 operate cooperatively with one another, it becomes possible to support trouble handling by observing invariable average processing time for each service, which depend neither on a degree of concentration of transactions nor on a mixture ratio, and thereby quickly and accurately detecting a location where an abnormality has occurred. Additionally, by having data under a normal condition previously collected by conducting the training run in advance, it becomes possible to detect, during an abnormality detection operation, an abnormality with minimal computation which is computation of the residual, and also, it becomes possible to detect an abnormality quickly through an on-line operation. Furthermore, even in a case where the training run is not conducted, abnormalities of various natures can be adequately detected by monitoring both of the residual and the processing time as appropriate. Additionally, accuracy of the abnormality detection can be further enhanced by having not only start and end of the transaction but also a waiting time taken into consideration in the processing of computing, the waiting time occurring in compliance with specifications of a communication protocol.

While the present invention has been described by using the embodiment, a technical scope of the present invention is not limited to the scope described in the abovementioned embodiment. It is apparent to those skilled in the art that various modifications or improvements can be made to the abovementioned embodiment. It is apparent from the scope of claims that embodiments to which such modifications or improvements have been made can also be included in the technical scope of the present invention.

What is claimed is:

1. A detection apparatus for detecting, in an information processing system provided with a plurality of information processing apparatuses, an information processing apparatus in which an abnormality has occurred, the detection apparatus comprising:
a storage unit for storing an average processing time per service previously estimated for a plurality of services provided by each of the information processing apparatuses;
an acquisition unit for acquiring a plurality of communication packets mutually transmitted and received among information processing apparatuses during a period subjected to detection of an abnormality;
a number-of-times computing unit for computing, by using the acquired plurality of communication packets, the number of calling times per service that a service provided by each of the information processing apparatuses is called by the other information processing apparatuses;
a busy time computing unit for computing a busy time, which is a total amount of time when transactions for processing services are performed, for each of the information processing apparatuses;
a deviation judging unit for judging, for each of the information processing apparatuses, whether a point corresponding to coordinate values indicated by the computed number of calling times and the computed busy time deviates, beyond a predetermined criterion, from a hyperplane indicated by the average processing time per service, in a multidimensional space formed by coordinate axes indicating the number of calling times per service and by a coordinate axis indicating the busy time; and
an output unit for outputting information indicating an information processing apparatuses judged as having the coordinate values whose point deviates from the hyperplane beyond the predetermined criterion, as the information processing apparatus in which an abnormality has occurred during the subject period.

2. The detection apparatus according to claim 1, further comprising a service demand computing unit, wherein:
the acquisition unit acquires a plurality of communication packets mutually transmitted and received among the information processing apparatuses in a predetermined trial period preceding the subject period;
by using communication packets acquired in each of a plurality of divided periods obtained by dividing the trial period, the number-of-times computing unit computes the number of calling times that each of the information processing apparatuses is called by the other information processing apparatuses per information processing apparatus and service in the divided period;
by using the communication packets acquired in each of the divided periods, the busy time computing unit computes a busy time which is a total amount of time when each of the information processing apparatuses performs the transaction in the divided period;
with respect to each of the information processing apparatuses and each of the divided periods, the service demand computing unit computes an average processing time per service that minimizes an index indicating a difference between the busy time, and a sum of products obtained by multiplying the number of calling times for each service by an average processing time of transactions for processing the service; and
the service demand computing unit stores the average processing time per service in the storage unit.

3. The detection apparatus according to claim 2, wherein:
with respect to each of the information processing apparatuses and each of the divided periods, the service demand computing unit further computes a difference between the busy time and a sum of the products obtained by multiplying the number of calling times for each service by average processing times for the service, and computes a variance of the difference in each of the divided periods;
for each of the information processing apparatuses, the storage unit further stores the computed variance in addition to the average processing time per service; and
for each of the information processing apparatuses, the deviation judging unit computes a difference between the busy time and a sum of the products obtained by multiplying the number of calling times for each service by average transactions processing times of processing the service in the subject period, and judges that the point corresponding to the coordinate values deviates from the hyperplane beyond the predetermined criterion, on condition that the difference is larger than the variance having been stored for the information processing apparatus.

4. The detection apparatus according to claim 3, wherein:
the service demand computing unit generates a normal equation for finding the average processing time per service that minimizes the sum of squares of the differences in the each of the divided periods, and computes the average processing time per service by solving the normal equation for finding the average processing time per service.

5. The detection apparatus according to claim 3, wherein:
the number-of-times computing unit judges whether or not each of the communication packets acquired during each of the divided periods is a communication packet for calling a service, by using any of a destination address URL and service identification information contained in the communication packet, and then computes the number of the communication packets for calling each of the services as the number of calling times of the service.

6. The detection apparatus according to claim 1, further comprising a service demand computing unit, wherein:
the acquisition unit acquires a plurality of communication packets mutually transmitted and received among the information processing apparatuses in each of the plurality of the subject periods which sequentially elapse;
every time each of the subject periods elapses, the service demand computing unit computes the average processing time per service in each of the information processing apparatuses, by using the plurality of communication packets acquired in the previously elapsed subject periods, and stores the average processing time per service in the storage unit as an estimated value of the average processing time per service;
the number-of-times computing unit computes the number of calling times per service for each of the information processing apparatuses, by using the plurality of communication packets acquired during the current subject period;
the busy time computing unit computes the busy time for each of the information processing apparatuses, by using the communication packets acquired during the current subject period; and
as the information processing apparatus in which an abnormality has occurred during the subject period, the output unit outputs the information that indicates an information processing apparatus judges as having the coordinate values whose point deviates from the hyperplane beyond the predetermined criterion.

7. The detection apparatus according to claim 6, further comprising a difference judging unit for judging, for each of the information processing apparatuses, whether the average processing time per service having been computed immediately before differs from the currently computed average processing time per service beyond a predetermined criterion, every time the average processing time per service is computed by the service demand computing unit, wherein:
as the information processing apparatuses where an abnormality has occurred in the current subject period, the output unit outputs information that indicates an information processing apparatus whose coordinate values indicating the point judged as not deviating from the hyperplane, on condition that the foregoing average processing times differ from each other beyond the predetermined criterion.

8. The detection apparatus according to claim 1, wherein:
for each of the information processing apparatuses, the busy time computing unit judges a period from a time of acquiring a communication packet for calling any one of services provided by the information processing apparatuses, to a time of acquiring a communication packet for returning a processing result of the called service, as an in-processing time period when each of the information processing apparatuses is processing transactions, and computes a length of the in-processing time period as a busy time.

9. The detection apparatus according to claim 8, wherein:
with respect to each of the information processing apparatuses, the busy time computing unit excludes a certain period from the busy time even within the period from a time of acquiring a communication packet for calling any one of services provided by the information processing apparatuses, to a time of acquiring a communication packet for returning a processing result of the called service, the certain period starting from a time when the information processing apparatuses transmits a communication packet related to the service under processing to a different information processing apparatus, and ending at a time when the different information processing apparatus transmits a communication packet related to the service as a reply.

10. A program causing a computer to function as the detection apparatus, in an information processing system provided with a plurality of information processing apparatuses, an information processing apparatus in which an abnormality has occurred, the program comprising:
a storage unit for storing an average processing time per service previously estimated for a plurality of services provided by each of the information processing apparatuses;
an acquisition unit for acquiring a plurality of communication packets mutually transmitted and received among information processing apparatuses during a period subjected to detection of an abnormality;
a number-of-times computing unit for computing, by using the acquired plurality of communication packets, the number of calling times per service that a service provided by each of the information processing apparatuses is called by the other information processing apparatuses;
a busy time computing unit for computing a busy time, which is a total amount of time when transactions for processing services are performed, for each of the information processing apparatuses;
a deviation judging unit for judging, for each of the information processing apparatuses, whether a point corresponding to coordinate values indicated by the computed number of calling times and the computed busy time deviates, beyond a predetermined criterion, from a hyperplane indicated by the average processing time per service, in a multidimensional space formed by coordinate axes indicating the number of calling times per service and by a coordinate axis indicating the busy time; and
an output unit for outputting information indicating an information processing apparatuses judged as having the coordinate values whose point deviates from the hyperplane beyond the predetermined criterion, as the information processing apparatus in which an abnormality has occurred during the subject period.

11. A detection method for detecting, in an information processing system provided with a plurality of information processing apparatuses, an information processing apparatus in which an abnormality has occurred, the detection method comprising the steps of:
storing an average processing time per service previously estimated for a plurality of services provided by each of the information processing apparatuses;
acquiring a plurality of communication packets mutually transmitted and received among information processing apparatuses during a period subjected to detection of an abnormality;
computing, by using the acquired plurality of communication packets, the number of calling times per service that a service provided by each of the information processing apparatuses is called by the other information processing apparatuses;
computing a busy time, which is a total amount of time when transactions for processing services are performed, for each of the information processing apparatuses;
judging, for each of the information processing apparatuses, whether a point corresponding to coordinate values indicated by the computed number of calling times and the computed busy time deviates, beyond a predetermined criterion, from a hyperplane indicated by the average processing time per service, in a multidimensional space formed by coordinate axes indicating the number of calling times per service and by a coordinate axis indicating the busy time; and
outputting information indicating an information processing apparatuses judged as having the coordinate values whose point deviates from the hyperplane beyond the predetermined criterion, as the information processing apparatus in which an abnormality has occurred during the subject period.
